(19) United States
(12) Patent Application Publication
(10) Pub. No.: US 2008/0043480 A1
(43) Pub. Date: Feb. 21, 2008

(54) LED MODULE HAVING COOLING APPARATUS

(75) Inventor: Jong-Hyun KONG, Masan-si (KR)

Correspondence Address: MITCHELL P. BROOK;LUCE, FORWARD, HAMILTON & SCRIPPS LLP, 11988 EL CAMINO REAL, SUITE 200, SAN DIEGO, CA, 92130, US

(73) Assignee: URBAN ENVIRONMENT ENGINEERING CO., LTD., Gwangju (KR)

(21) Appl. No.: 11/837,034

(22) Filed: Aug. 10, 2007

(30) Foreign Application Priority Data
Aug. 21, 2006 (KR) 10-2006-0078731

(51) Int. Cl. F21V 29/00

(52) U.S. Cl. 362/373

(57) ABSTRACT

A light emitting diode (LED) module having a cooling apparatus is provided, including a substrate having a plurality of LEDs installed thereon and installed on a bottom surface of the substrate, a container containing a heat exchange medium, and a peltier device installed on at least one side of the container to cool the heat exchange medium contained inside the container. The LED module can improve a dissipation characteristic of heat generated from a high-brightness LED while preventing the LED from degrading due to heat.

### CROSS-REFERENCE TO RELATED APPLICATION

This application claims priority from Korean Patent Application No. 10-2006-0078731 filed on Aug. 21, 2006 in the Korean Intellectual Property Office, the disclosure of which is incorporated herein by reference in its entirety.

### BACKGROUND OF THE INVENTION

1. Field of the Invention

The present invention relates to a light emitting diode (LED) module, and more particularly, to a light emitting diode (LED) module having a cooling apparatus for cooling the LED module with a plurality of LEDs installed on a board.

2. Description of the Related Art

In general, LEDs are widely used in highly illuminated projectors, backlights, and lighting devices. Particularly, in recent years, there has been gradually increasing demand for development for less-power consuming, high-power LEDs. While such LEDs have several advantages of a long lifespan, less power consumption, environmental friendliness, compactness, and so on, they still have a poor light efficiency. That is to say, in spite of several advantages, the LEDs have only a light efficiency of approximately 20 to approximately 30%.

As described above, the heat generated from the LED deteriorates the LED, shortening the lifetime. Accordingly, it is necessary to provide heat dissipation means in a high-power LED.

Korean Patent Published Application No. 2005-0086391 discloses an LED package printed circuit board (PCB) and a manufacturing method thereof. The disclosed PCB is provided with a plate-shaped heat pipe.

Korean Patent Published Application No. 2006-008605 discloses a heat dissipation structure of an LED package and an LED package having the heat dissipation structure. The disclosed LED package includes an LED chip, a metal slug adhered to an LED chip using an adhesive layer, and a molding surrounding the LED chip, the metal slug including an emissive wall surrounding the LED chip and a slug board formed outside the emissive wall.

The aforementioned LED package having a cooling capability or a heat dissipation structure of the LED package has a complex configuration and performs heat dissipation by transmitting heat to the air, which makes it difficult to achieve a sufficiently high cooling effect. Specially, in a case of a high-power LED, deterioration of the LED due to heat cannot be prevented by means of the heat dissipation structure.

### SUMMARY OF THE INVENTION

The present invention provides a light emitting diode (LED) module having a cooling apparatus, which can improve a dissipation characteristic of heat generated from a high-brightness LED while preventing the LED from degrading due to heat.

The present invention also provides an LED module having a cooling apparatus, by which a lamp and a backlight using high-power LEDs can be fabricated.

The present invention also provides an LED module having a cooling apparatus, which can maximize a cooling efficiency by cooling LEDs using a heat exchange medium.

The above and other objects of the present invention will be described in or be apparent from the following description of the preferred embodiments.

According to an aspect of the present invention, there is provided a light emitting diode (LED) module having a cooling apparatus is provided, including a substrate having a plurality of LEDs installed thereon and installed on a bottom surface of the substrate, a container containing a heat exchange medium, and a peltier device installed on at least one side of the container to cool the heat exchange medium contained inside the container.

In the present invention, the container has at least one air vent penetrating a case of the container, and heat dissipation fins may be installed on an outer surface of at least one air vent or the container.

### BRIEF DESCRIPTION OF THE DRAWINGS

The above and other features and advantages of the present invention will become more apparent by describing in detail preferred embodiments thereof with reference to the attached drawings in which:

FIG. 1 is a perspective view of an LED module having a cooling apparatus according to an embodiment of the present invention;

FIG. 2 is a perspective view of an LED module having a cooling apparatus according to another embodiment of the present invention;

FIG. 3 is a cross-sectional view of the LED module shown in FIG. 2;

FIG. 4 is a perspective view of an LED module having a cooling apparatus according to still another embodiment of the present invention;

FIG. 5 is a partly exploded perspective view of an LED module having a cooling apparatus according to another embodiment of the present invention; and

FIGS. 6, 7 and 8 are partly exploded perspective views of LED modules having an auxiliary heat transmission member installed in a container according to another embodiment of the present invention.

### DETAILED DESCRIPTION OF THE INVENTION

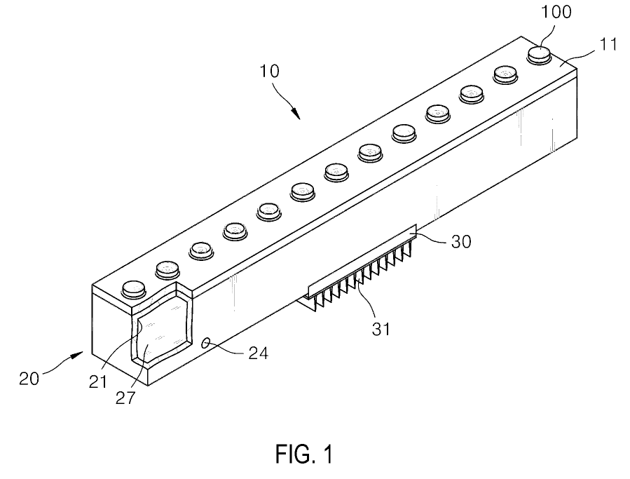

FIG. 1 is a perspective view of an LED module having a cooling apparatus according to an embodiment of the present invention.

Referring to FIG. 1, the LED module 10 having a cooling apparatus according to an embodiment of the present invention includes a substrate 11 having a plurality of LEDs 100 installed thereon, a container 20 installed on the bottom surface of the substrate 11 and containing a heat exchange medium 27, and a peltier device 30 installed on at least one side of the container 20, for cooling the heat exchange medium 27 contained inside the container 20.

Various components of the aforementioned LED module will now be described in greater detail.

Each of the LEDs 100 may be a high-power LED necessitating a large amount of heat dissipated. For example, the LED may be formed by attaching chips to a housing having a reflective film and wire-bonding the chips with electric terminals installed on the housing. However, the configuration of each LED is not limited to this illustrated example. The substrate 11 having the LEDs 100 installed thereon supports the LEDs 100 and includes electrode patterns (not shown) for supplying the respective LEDs 100 with current. The substrate 11 is preferably a metal PCB having an insulating layer to be insulated from the electrode patterns (not shown), but not limited thereto.

The container 20 is configured to incorporate a case 21 having an inner space filled with a heat exchange medium 27 so that heat radiated from the LEDs 100 through the substrate 11. In order to facilitate heat transmission, a gap between the container 20 and the substrate 11 is preferably adhered by means of a heat-conducting adhesive agent. In addition, the container 20 is preferably made from a material having a high heat transmission coefficient, such as aluminum, copper, a copper alloy, or the like.

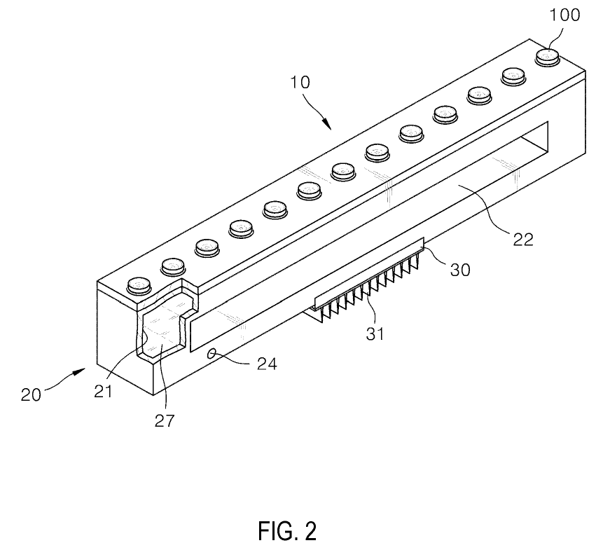

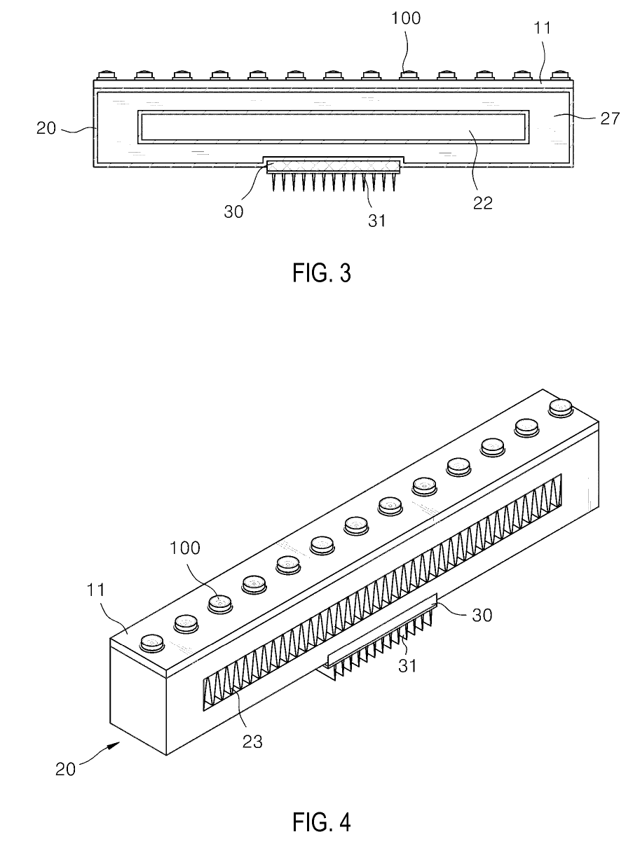

As shown in FIGS. 2 through 4, the container 20 may have at least one air vent 22 penetrating the container 20. Referring to FIG. 4, the air vent 22 may have heat dissipation fins 23 installed therein. The heat dissipation fins 23 may be attached to a surface of the container 20. In addition, a safety vent 24 for preventing an internal pressure of the container 20 from abnormally increasing may be installed in the container 20. Here, the safety vent 24 may be a notch formed at the container 20 in a predetermined pattern or a relief valve configured to be opened or closed at a predetermined pressure.

A peltier device 30 for exhausting heat from the heat exchange medium 27 is installed at one side of the container 20. The peltier device 30 is installed such that a cooling portion thereof is attached to the surface of the container 20 and a heat dissipation portion thereof is exposed to the air. Heat dissipation fins 31 for dissipating heat may be installed on the surface of the peltier device 30 exposed to the air.

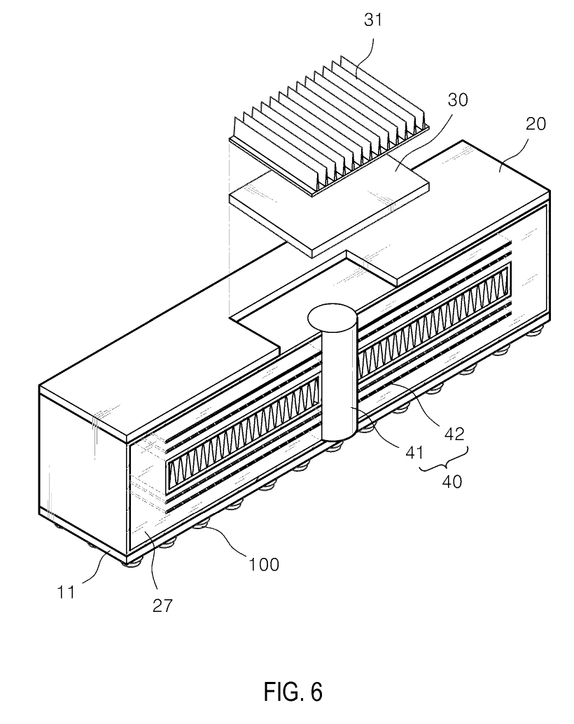

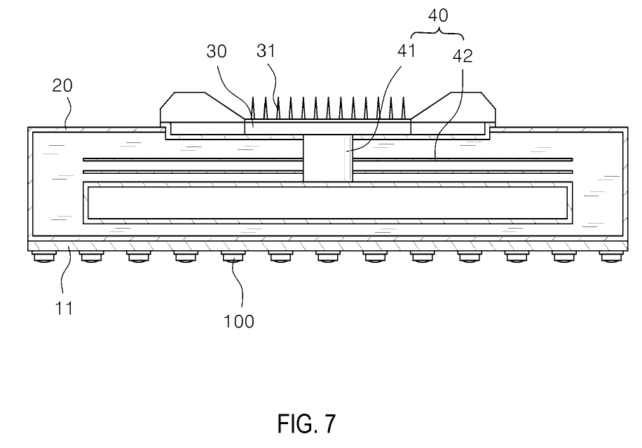

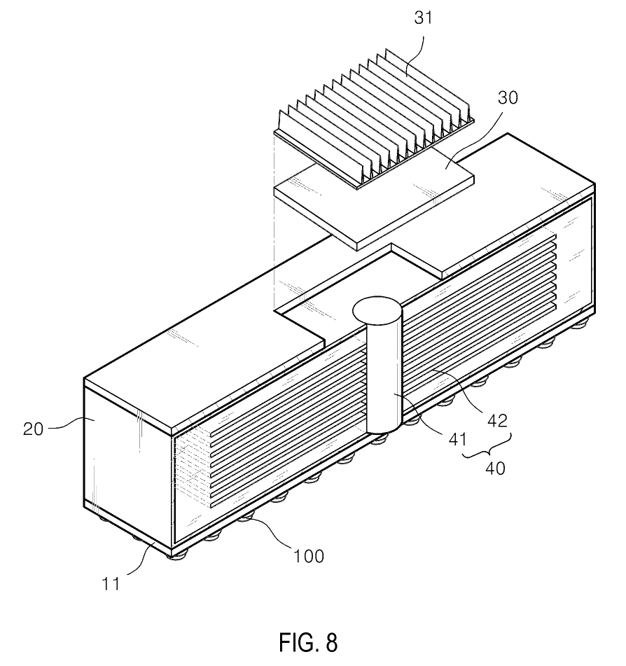

FIGS. 6, 7 and 8 are partly exploded perspective views of LED modules having an auxiliary heat transmission member installed in a container according to another embodiment of the present invention. In the current embodiment, substantially the same elements as those in the previous embodiment are denoted as the same reference numerals.

Referring to the drawings, the container 20 incorporates an auxiliary heat transmission unit 40 for transmitting heat from the heat exchange medium 27 contained in the container 20 to the peltier device 30. The auxiliary heat transmission unit 40 includes a first heat transmission member 41 extending inwardly from a portion at which the peltier device 30 is installed, and a plurality of second heat transmission members 42 extending radially from the first heat transmission member 41. Here, the second heat transmission member 42 may be formed of a foil or rod. The auxiliary heat transmission unit 40 is not limited to the illustrated embodiment and may be implemented as a plurality of protrusions projecting from the internal surface of the container 20.

The aforementioned LED module having a cooling apparatus operates as follows.

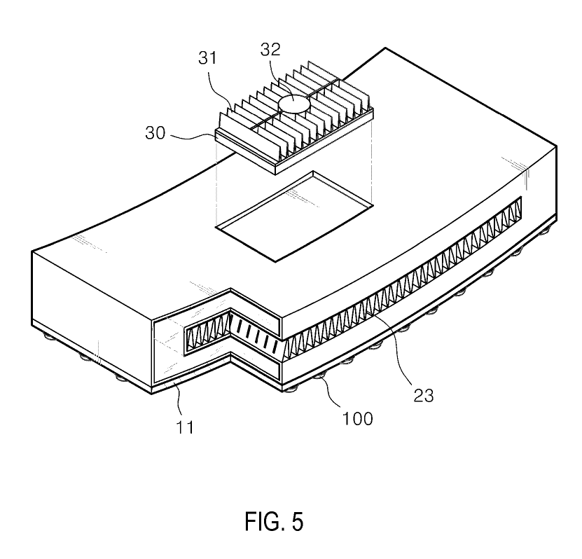

As shown in FIG. 5, in the heat dissipation fins 31, a heat pipe 32 is installed in contact with the peltier device 30 to transmit heat generated from the peltier device 30 to the heat dissipation fins 31. The aforementioned container 20 may vary in its shape according to characteristics of the LEDs 100 or a mounting portion of the substrate 11 supporting the LEDs 100. Further, as shown in FIG. 5, the mounting portion of the substrate 11 may be curved.

As high-power LEDs 100 installed on the substrate 11 are driven for illuminations, a large amount of heat is generated and transmitted to the heat exchange medium 27 of the container 20 through the substrate 11.

The heat transmitted to the heat exchange medium 27 in such a way is dissipated through the surface of the container 20 and pumped to the outside by the peltier device 30. Accordingly, the LEDs 100 can be constantly cooled.

Particularly, since the case 21 of the container 20 is made of an aluminum or copper plate having a relatively high heat transmission coefficient, the container 20 exhibits good heat dissipation characteristics, thus effectively performing a function as a heat sink. The container 20 has the air vent 22, and the air vent 22 includes the heat dissipation fins 23. In addition, a heat transmission unit for transmitting heat from the heat exchange medium 27 to the peltier device 30 is installed inside the container 20, thereby further improving heat dissipating characteristics.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A light emitting diode (LED) module having a cooling apparatus, comprising:
a substrate having a plurality of LEDs installed thereon and installed on a bottom surface of the substrate;
a container containing a heat exchange medium; and
a peltier device installed on at least one side of the container to cool the heat exchange medium contained inside the container.

2. The LED module of claim 1, wherein the container has at least one air vent penetrating a case of the container.

3. The LED module of claim 2, wherein heat dissipation fins are installed on an outer surface of at least one air vent or the container.

4. The LED module of any one of claims 1 through 3, wherein a safety vent for preventing the pressure of an inner space of the container from exceeding a predetermined level is installed in the container.

5. The LED module of claim 1, wherein the container comprises an auxiliary heat transmission unit for transmitting heat from the heat exchange medium to the peltier device.

6. The LED module of claim 5, wherein the auxiliary heat transmission unit includes a first heat transmission member extending inwardly from a portion at which the peltier device is installed, and a plurality of second heat transmission members extending radially from the first heat transmission member.
